(19) United States
(12) Patent Application Publication
(10) Pub. No.: US 2018/0313310 A1
(43) Pub. Date: Nov. 1, 2018

(54) FUEL MANIFOLD WITH REDUCED MAINTENANCE

(71) Applicant: Progress Rail Locomotive Inc., LaGrange, IL (US)

(72) Inventors: Timothy Joseph Paulson, Schereville, IN (US); Michael Anthony Bloome, Melrose Park, IL (US)

(73) Assignee: Progress Rail Locomotive Inc., LaGrange, IL (US)

(21) Appl. No.: 15/583,016

(22) Filed: May 1, 2017

(51) Int. Cl. F02M 37/22; B01D 35/30; B01D 35/147

(52) U.S. Cl. CPC F02M 37/22; B01D 35/1475; B01D 35/30

(57) ABSTRACT

An end cap comprises a substantially annular cylindrical body defining a cylindrical axis and including an annular skirt portion defining a free open end along the cylindrical axis and a closed end opposite the free open end along the cylindrical axis, the body defining an interior space, and the annular skirt portion includes an outer circumferential surface including a threaded portion disposed proximate the free open end.

### TECHNICAL FIELD

The present disclosure relates to a method and apparatus for providing a fuel manifold or filter assembly requiring reduced maintenance in the field. Specifically, the present disclosure relates to a fuel manifold or filter assembly that is modified to have threaded attachment structure so that cap members may be threaded directly onto a filter body, eliminating the need for straps, screws or other fasteners, and seals such as gaskets to secure the cap members to the filter body in a fluid tight manner.

### BACKGROUND

Many existing engines such as locomotive engines sold under the tradename of EMD (Electro-Motive Diesel) and the like use mechanical unit injectors to supply fluid such as diesel fuel/oil to the engine. These engines typically have fuel filter assemblies that are designed to remove impurities and contaminants from the fuel so that these impurities and contaminants do not foul up the workings of the engine.

These filter assemblies often employ a fuel filter body or fuel manifold that has fuel filters attached to its underside and sight glasses attached to its top side. The sight glasses and fluid filters often have cylindrical configurations, with each sight glass mounted on top of the fuel filter body nearly concentrically with a corresponding filter. The sight glasses are transparent, allowing the operator of the engine to visually inspect if fuel is flowing through the fuel filter assembly as desired. More specifically, during normal operation, the sight glass above the filter nearest the engine will usually have some fuel/oil in it with little to no air bubbles being seen. The sight glass above the other filter farther away from the engine will often have no to little fuel/oil contained in that sight glass. If fuel/oil is seen in this glass, this may indicate that the system is clogged or insufficient fuel/oil is flowing through the system.

These sight glasses are often secured to the fuel filter body using a clevis type strap clamp and a fastener such as a thumb screw. During assembly, a gasket or other type of seal is disposed between the sight glass and the fuel filter body, helping to provide a fluid tight seal between the sight glass and the fuel filter body.

These type of diesel engines may experience a considerable amount of vibration. Consequently, parts of the engine such a fasteners, including the thumb screws used to attach the sight glasses to the fuel filter body, may become loose. Alternatively, the clevis type strap clamp may wear or deform. In either case, a leak may develop if the equipment is not maintained within regular inspection intervals and worn components are not replaced with original equipment manufactured components.

Therefore, a more reliable and durable manner of attaching members to a fuel filter body is desirable. In some cases, it may be desirable still to allow an operator of an engine to know if fuel/oil is flowing through fuel filter assembly suitably.

### SUMMARY

An end cap according to an embodiment of the present disclosure is provided for use with a fuel filter assembly including a fuel filter body. The end cap may comprise a substantially annular cylindrical body defining a cylindrical axis and including an annular skirt portion defining a free open end along the cylindrical axis and a closed end opposite the free open end along the cylindrical axis, the body defining an interior space, and the annular skirt portion includes an outer circumferential surface including a threaded portion disposed proximate the free open end.

A fuel filter body according to an embodiment of the present disclosure is provided for use with a plurality of end caps and filters as part of a fuel filter assembly. The fuel filter body may comprise a body defining a top surface and a bottom surface, wherein the bottom surface includes a plurality of attachment portions configured to couple with a plurality of filters, and the top surface defines a plurality of annular recesses, dividing the body into a first central core portion and a second central core portion, each annular recess defining a bottom face and a cylindrical surface with threads extending from the top surface toward the bottom face of the annular recess.

A filter assembly according to an embodiment of the present disclosure is provided. The filter assembly may comprise a filter body including a body defining a top surface and a bottom surface, wherein the bottom surface includes a plurality of attachment portions configured to couple with a plurality of filters. The top surface may define first and second annular recesses, dividing the body into a first central core portion and a second central core portion, each annular recess defining a bottom face and a concave cylindrical surface facing a central core portion and including threads extending from the top surface toward the bottom face of the annular recess, a plurality of filters coupled to the attachment portions of the filter body, a first silo including a first substantially annular cylindrical body defining a first cylindrical axis and including a first annular skirt portion defining a first free open end along the first cylindrical axis and a first closed end opposite the first free open end along the first cylindrical axis, the first substantially annular cylindrical body defining a first interior space, and the first annular skirt portion includes a first outer circumferential surface including a first threaded portion disposed proximate the first free open end, the first threaded portion of the first silo mating with the threads of the first annular recess, forming a first interface, and a second silo including a second substantially annular cylindrical body defining a second cylindrical axis and including a second annular skirt portion defining a second free open end along the second cylindrical axis and a second closed end opposite the second free open end along the second cylindrical axis, the second substantially annular cylindrical body defining a second interior space, and the second annular skirt portion includes a second outer circumferential surface including a second threaded portion disposed proximate the second free open end, the second threaded portion of the second silo mating with the threads of the second annular recess, forming a second interface.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a fuel filter assembly that may use various screwed on end caps according to various embodiments of the present disclosure.

FIG. 2 depicts how a safety wire may be employed to prevent the unintentional removal of the end caps of FIG. 1.

FIG. 3 illustrates the fuel filter assembly of FIG. 2 with the end caps removed, revealing the pressure relief valves and the standpipe of the fuel filter assembly.

FIG. 4 is an alternate perspective view of the fuel filter assembly of FIG. 3, with the pressure relief valves and standpipe removed so that the threaded bores of the core members of the fuel filter body are revealed.

FIG. 5 is a sectional view of the fuel filter body of FIG. 4, revealing the flow passages of the fuel filter body.

FIG. 6 is a perspective view of a fuel filter assembly similar to the assembly of FIG. 1 except that fuel pressure sensors are disposed at the top of the end caps for sensing whether fuel is flowing through the fuel filter assembly suitably.

FIG. 7 is a perspective view of another fuel filter assembly similar to that of FIG. 1 except that the end caps or fuel silos are attached using spanner wrench holes.

FIG. 8 contains a flow chart of use, manufacture or assembly for a filter assembly according to various embodiments of the present disclosure.

FIG. 9 is a schematic depicting the flow of fuel/oil through the filter assembly.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

Various embodiments of durable screw in end caps/fuel silos that may be mounted onto a modified version of the existing fuel filter bodies will now be described. The fuel filter body will now have threads machined into counter bored, cylindrical annular pockets. The external threads on the end caps/fuel silos may be screwed in two locations of the internal threads of the newly designed fuel filter body, with a sealant applied to the threads. The internal fuel flow functionality of the fuel filter assembly in certain embodiments may remain the same as the original version. The durable connections of the end caps/fuel silos may provide long term reliability, where the original design required periodic maintenance and inspections at prescribed intervals. When the caps are properly installed/torqued into place they will inherently resist rotational loosening due to engine/locomotive vibration exposure.

In many embodiments, the end caps/fuel silos are opaque (e.g. made from stainless steel) so visual inspection may not be possible. Therefore, many embodiments may include pressure sensors which monitor fuel flow and indicate when an adverse condition exists internally. This effectively replaces the previous “see” through glass indication of fuel flow although this may feature may be used in other embodiments. For example, various embodiments of the present application may be made from transparent or translucent materials such as polycarbonate that are compatible with the fluid being used such as fuel in the system. It is contemplated that the apparatus and method discussed herein may be used with any sort of filter or fluid management system.

As used herein, it is to be understood that the term “fuel” may include oil or lubricant as is often the case with diesel engines. Accordingly, the term “oil” or “lubricant” may be omitted when discussing the fuel but it is to be understood that oil or lubricant may be included in the fuel mixture in any embodiment without specifically stating so.

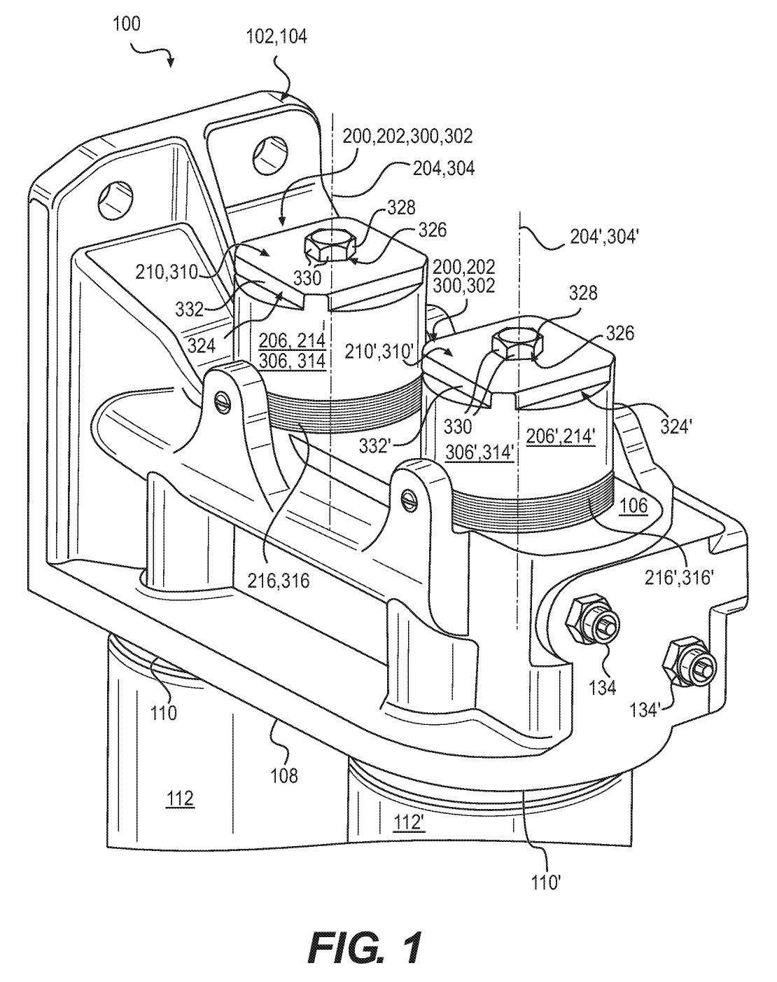

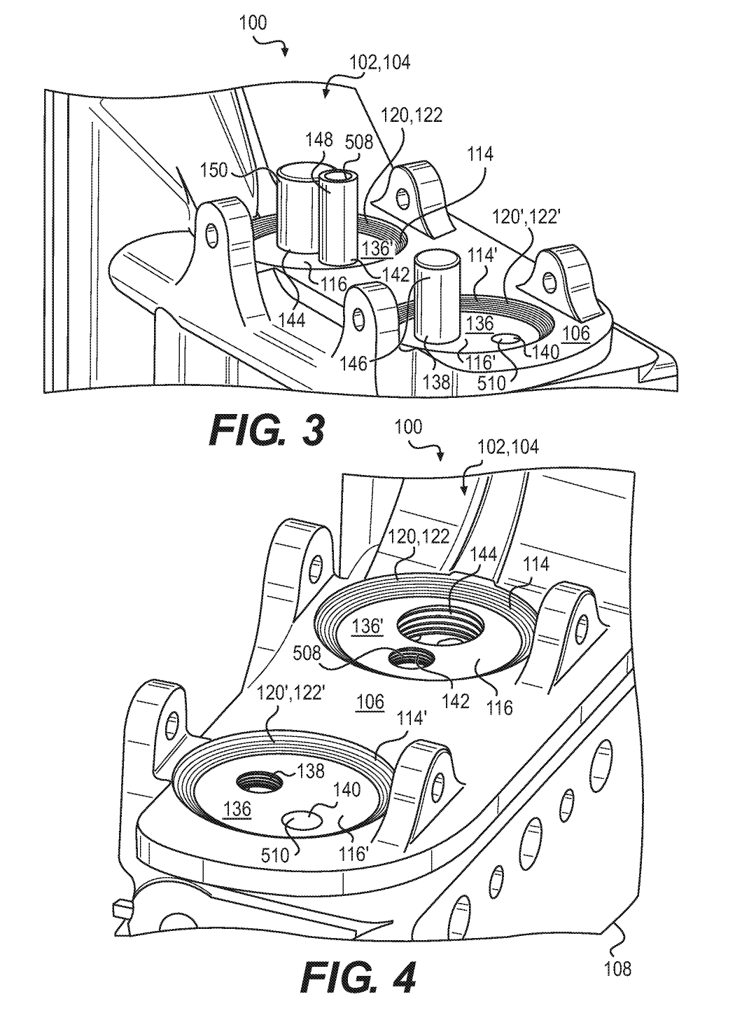

Looking at FIGS. 1, and 3 thru 7, various embodiments of a fuel filter assembly of the present disclosure are shown. Such fuel filter assemblies 100 may comprise a fuel filter body or manifold 102 including a body 104 defining a top surface 106 and a bottom surface 108. The bottom surface 108 may include a plurality of attachment portions 110 configured to couple with a plurality of filters 112, 112′ in a manner known in the art. On the other hand, the top surface 106 may define first and second annular recesses 114, 114′, dividing the body 104 into a first central core portion 116 and a second central core portion 116′. Each annular recess 114, 114′ may define a bottom face 118 and a concave cylindrical surface 120 facing a central core portion 114. The concave cylindrical surface 120 may have threads 122 extending from the top surface 106 toward the bottom face 118 of the annular recess 114. As shown in FIGS. 3 thru 7, these threads 122 may extend all the way to bottom face 118 in some embodiments. This may not be the case for other embodiments.

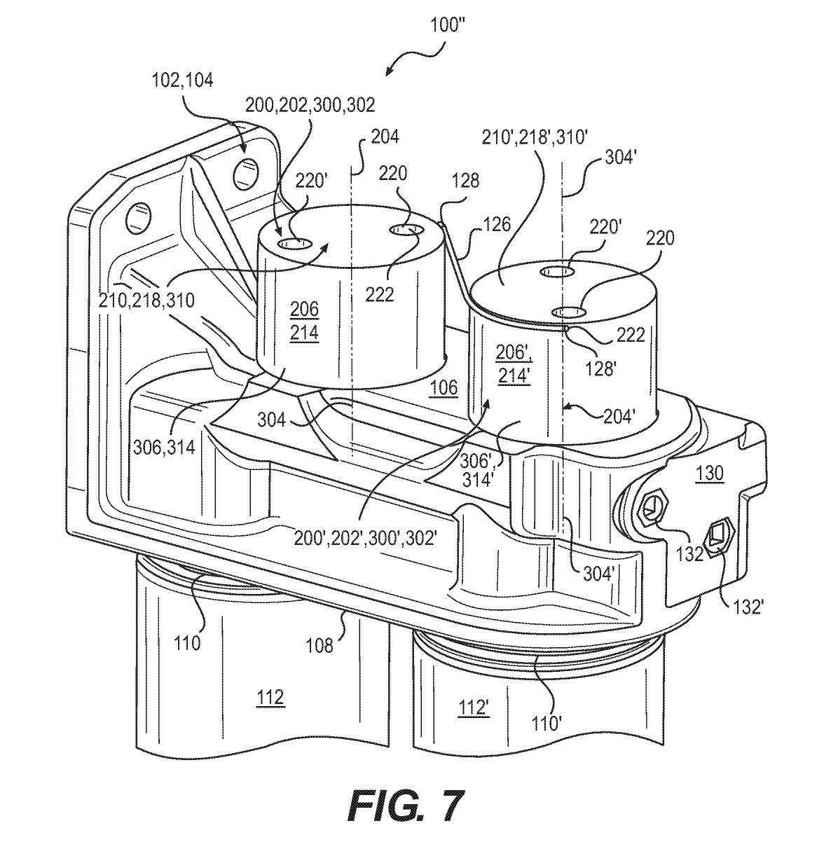

As best understood with reference to FIGS. 1 and 7, a plurality of filters 112 may be coupled to the attachment portions 110 of the fuel filter body 102. For example, in some embodiments, the filters are arranged to be in fluid communication in series so that one filter may be designed to remove water and/or large particulates from the fuel while the second filter may be configured to remove smaller particulates. In other embodiments, as will be described in more detail later herein, the fuel filters may be arranged in parallel so that both filters serve the same function when filtering the fuel. Any sort of arrangement, combination, number and type of filters, etc. is possible for any of the embodiments of the present disclosure including those shown in FIGS. 1, and 3 thru 7.

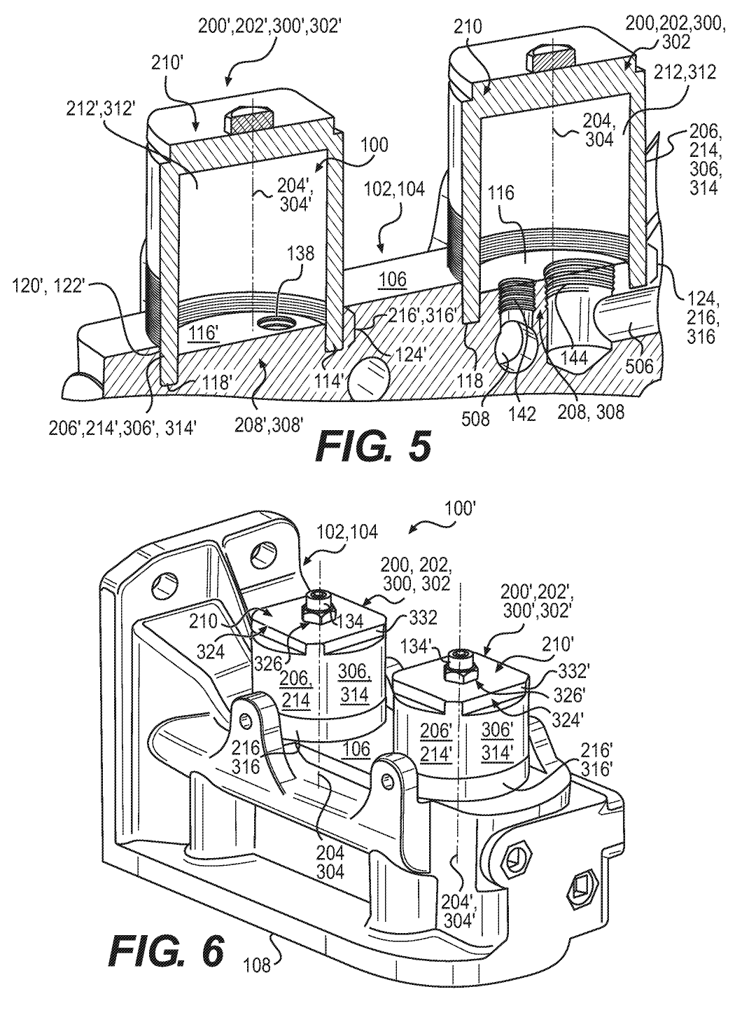

A first fuel silo 200, which may also be referred to as an end cap, may be provided to be secured to the top surface 106 of the fuel filter body 102. The first fuel silo 200 may include a first substantially annular cylindrical body 202 defining a first cylindrical axis 204. This body 202 may also include a first annular skirt portion 206 defining a first free open end 208 along the first cylindrical axis 204 and a first closed end 210 opposite the first free open end 208 along the first cylindrical axis 204 as best seen in FIG. 5. The first substantially annular cylindrical body 202 defines a first interior space 212 and the first annular skirt portion 206 includes a first outer circumferential surface 214 including a first threaded portion 216 disposed proximate the first free open end 208. The first threaded portion 216 of the first fuel silo 200 mates with the threads 122 of the first annular recess 114, forming a first interface 124.

Likewise, a second fuel silo 200′ (or second end cap) may also be provided to be secured to the top surface 106 of the fuel filter body 102. The second fuel silo 200′ may include a second substantially annular cylindrical body 202′ defining a second cylindrical axis 204′. This body 202′ may also include a second annular skirt portion 206′ defining a second free open end 208′ along the second cylindrical axis 204′ and a second closed end 210′ opposite the second free open end 208′ along the second cylindrical axis 204′. The second substantially annular cylindrical body 202′ defines a second interior space 212′ and the second annular skirt portion 206′ includes a second outer circumferential surface 214′ including a second threaded portion 216′ disposed proximate the second free open end 208′. The second threaded portion 216′ of the second fuel silo 200′ mates with the threads 122′ of the second annular recess 114′, forming a second interface 124′.

In many embodiments a sealant is applied at the first interface 124 between the first fuel silo 200 and the fuel filter body 102 and at the second interface 124′ between the second fuel silo 200′ and the fuel filter body 102. For example, a sealant may be applied to the threads 216, 216′ of the first and second fuel silos 200, 200′ before they are mounted onto the fuel filter body 102. In other embodiments, pipe tap threads may be used along with pipe sealant to effectuate a fluid tight seal, etc. Also, the first and second fuel silos may be identically configured but this may not be the case in other embodiments. In like fashion, the plurality of annular recesses 114, 114′ may also be similarly configured to each other and the first and second central core portions 116, 116′ may also be similarly configured. The first and second core portions 116, 116′ may be slightly recessed compared to the top surface 106 of the fuel filter body 102 (see FIG. 5). This may not be the case for other embodiments and the configuration of any of these features may be varied as needed or desired.

Focusing now on FIG. 7, the first and second fuel silos 200. 200′ may each include a closed end 210 defining a top surface 218 that defines at least one hole 220 disposed proximate the annular skirt 206. The annular skirt 206 for both fuel silos may define a cross-bore 222 that extends in a direction non-parallel to the cylindrical axis 204 from the outer circumferential surface 214 to the at least one hole 220 disposed proximate the annular skirt 206. More particularly, the top surface of each fuel silo 200 may include a circular array with two similarly configured holes 220, 220′ and cross-bores 222 that are rotated about the cylindrical axis 204 an angle of 180 degrees. A tether 126 or safety wire may be attached to the fuel silos 200 with pigtails 128 extending through the cross-bores 222 and that are retained within the holes 220 so that the pigtails 128 are not easily removed from the fuel silos 200.

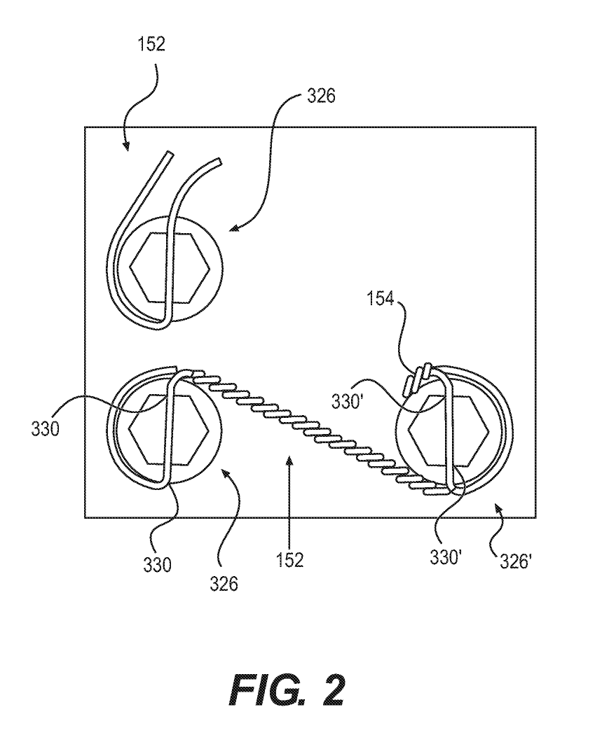

As seen in FIG. 7, this tether may be attached on opposite sides of the fuel silos 200 such that the tether 126 forms an “s” shape. As a result of the attachment of the tether 126 to the fuel silos, rotation of one fuel silo in one direction to loosen that silo tends to tighten the other silo, which prohibits the loosening of the first silo, and vice versa. Hence, the unintentional removal of the fuel silos is less likely, requiring the user to intentionally remove the tether 126 first. This will be explained in further detail later herein with respect to FIGS. 1 and 2.

As can also be seen in FIG. 7, the free end 130 of the fuel filter body 102 has flow passages whose ends are sealed by plugs 132. These plugs 132 may be replaced with pressure sensors 134 for monitoring the flow of fuel in the fuel filter assembly 100 similar to what is shown in FIG. 1 if so desired. Also, fuel pressure sensors 134 may also be incorporated into the fuel silos 200 of FIG. 7 similar to what is shown in FIG. 6 if so desired. Other arrangements are possible. In some embodiments, no pressure sensors may be used.

Turning now to FIGS. 3 thru 5, the second central core 116′ of the fuel filter body 102 may define a first top face 136 defining a first threaded bore 138 and a second unthreaded bore 140. Similarly, the first central core 116 of the fuel filter body 102 may define a second top face 136′ defining a third threaded bore 142 and a fourth threaded bore 144. As shown, the third threaded bore 142 defines a first diameter and the fourth threaded bore 144 defines a second diameter and the first diameter is less than the second diameter. This structure allows a first relief valve 146 to be coupled to the first threaded bore 138, a standpipe 148 to be coupled to the third threaded bore 142, and a second relief valve 150 to be coupled to the fourth threaded bore 144 (see FIG. 3). Other arrangements are possible in other embodiments. Of course, the interior space 122 of any end cap or fuel silo 200 as discussed herein would be designed to provide suitable clearance about any relief valve, standpipe, or any other structure. The use of these components will be discussed in more detail later herein. Also, the interior space may be adjusted to provide the desired volume for containing fuel or other fluid.

Various embodiments of an end cap that may be used with a fuel filter assembly including a fuel filter body will now be discussed. Referring now to FIGS. 1, and 5 thru 7, the end cap 300 comprises a substantially annular cylindrical body 302 defining a cylindrical axis 304 and including an annular skirt portion 306 defining a free open end 308 along the cylindrical axis 304 and a closed end 310 opposite the free open end 308 along the cylindrical axis 304. The body 302 also defines an interior space 312 and the annular skirt portion 306 includes an outer circumferential surface 314 including a threaded portion 316 disposed proximate the free open end 308.

For the embodiment of the end cap 300 depicted in FIG. 1, the body 302 includes a large faceted portion 324 that is disposed proximate the closed end 310 and a small faceted portion 326 that is disposed on top of the large faceted portion 324. In some embodiments, the small faceted portion 326 includes a plurality of faces 328 defining surface normals that are substantially perpendicular to the cylindrical axis 304 of the body 302. A plurality of these faces 328 of the small faceted portion 326 may define a hole 330 extending through the small faceted portion 326 along a direction parallel with the surface normal. These holes 330 may allow the attachment of a tether 126 or safety wire similar to what has been discussed previously herein with respect to FIG. 7.

Looking now at FIGS. 1 and 2, an example of how a safety wire 152 or tether may be attached to the small faceted portion 326 can be seen. The safety wire 152 (e.g. 0.032 of an inch dia.) may be routed through the holes 330 of small faceted portion 326 of one end cap 300 and through the holes 330′ of the small faceted portion 326′ of the other end cap 300′ and then twisted therebetween and at the end of the wire 326 using pliers to form a pigtail 154 so that the safety wire 152 cannot be removed easily. The routing may be done from one diametrical side of one end cap to the opposing diametrical side of the other end cap, forming an “s” shape.

Consequently, any rotation imparted on one end cap 300 to loosen that end cap is resisted by the other end cap 300′ which is tightened and vice versa. Hence, the user is reminded not to remove an end cap 300 unless it is desired to do so. Also, vibration is less likely to loosen the end caps. For the embodiment shown in FIG. 1, it may be desirable that the small faceted portion 326 be integral with the end cap 300, be welded to the end cap 300, etc. so that movement imparted to the end cap 300 is necessarily transferred to the small faceted portion 326. Other methods may be employed to prevent disassembly such as attaching a serial identification plate to the end caps via adhesive or the like, etc.

In FIG. 6, the small faceted portion 326 is disposed about a pressure sensor 134. More specifically, the small faceted portion 326 may be part of a pressure sensor assembly that may be screwed into the top of an end cap. To that end, it may be convenient if the small faceted portion 326 take the form of a standard hex configuration (six sides, e.g. a standard 5/16-24 hex head) that is known in the art so that a wrench may be used to install and remove the pressure sensor assembly. Other configurations of the small faceted portion are possible.

For the embodiment of the end cap 300 shown in FIGS. 1 and 6, the large faceted portion 324 has essentially four sides 332. The large faceted portion 324 may made integral with the body 302 of the end cap 300 or could be made from a separate member that is welded onto the body of the end cap, etc. The sides 332 of the large faceted portion may be configured to allow a wrench or another similar tool to be used to attach or detach the end cap. Other configurations of the large faceted portion are possible or other structure may be provided to install or remove the end cap. For example, for the end cap 300 shown in FIG. 7, the two holes 220 provided on top of the end cap may be used with pin spanner socket adapter to fully torque the end cap 300 onto the fuel filter body 102 via the threaded interface 124 as shown in FIG. 5.

### INDUSTRIAL APPLICABILITY

In practice, an end cap or fuel silo, a fuel filter body, or a fuel filter assembly according to any embodiment described herein may be sold, bought, manufactured or otherwise obtained in an OEM or after-market context.

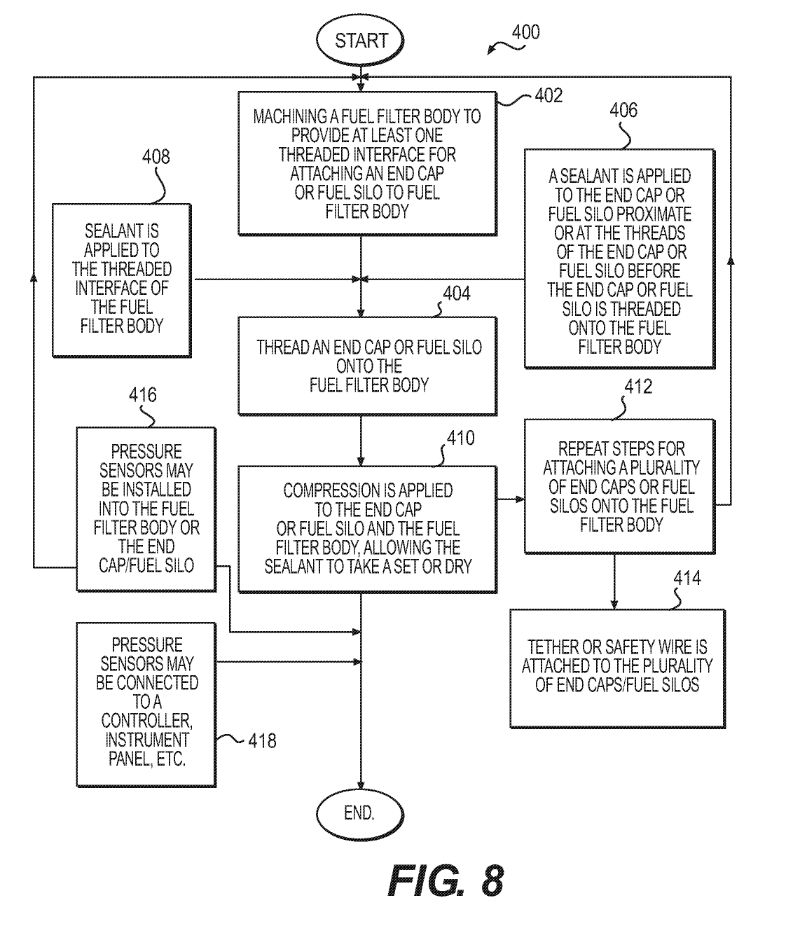

FIG. 8 contains a flow chart of use, manufacture or assembly for a fuel filter assembly according to various embodiments of the present disclosure. The method may be performed at the factory to supply an engine or a fuel filter assembly as original equipment, may be performed in the field, or some combination thereof. For example, machining to a fuel filter body may be performed in the field and then an end cap or fuel silo may be bought and installed onto the fuel filter body. Preliminary steps such as casting the fuel filter body or manufacturing an end cap/fuel silo are presumed.

The method 400 may comprise machining a fuel filter body to provide at least one threaded interface for attaching an end cap or fuel silo to the fuel filter body (step 402). Then, the user may thread an end cap or fuel silo onto the fuel filter body (step 404). In some embodiments, a sealant is applied to the end cap or fuel silo proximate or at the threads of the end cap or fuel silo before the end cap or fuel silo is threaded onto the fuel filter body (step 406). Alternatively, the sealant may be applied to the threaded interface of the fuel filter body (step 408). When a sealant is used, compression may be applied to the end cap or fuel silo and the fuel filter body, allowing the sealant to take a set or dry (step 410). These steps may be repeated for attaching a plurality of end caps or fuel silos onto the fuel filter body (step 412). If so, a tether or safety wire may be attached to the plurality of end caps/fuel silos (step 414) as described earlier herein with respect to FIGS. 2 and 7.

In some embodiments, pressure sensors are provided to detect if fuel is not flowing properly through the fuel filter assembly. If so, the pressure sensors may be installed into the fuel filter body or the end cap/fuel silo (step 416). This step may be performed before or after the end cap/fuel silo has been attached to the fuel filter body. Then, the pressure sensors may be connected to a controller, instrument panel, etc. (step 418) so that the signals sent by the pressure sensors may be monitored by the operator.

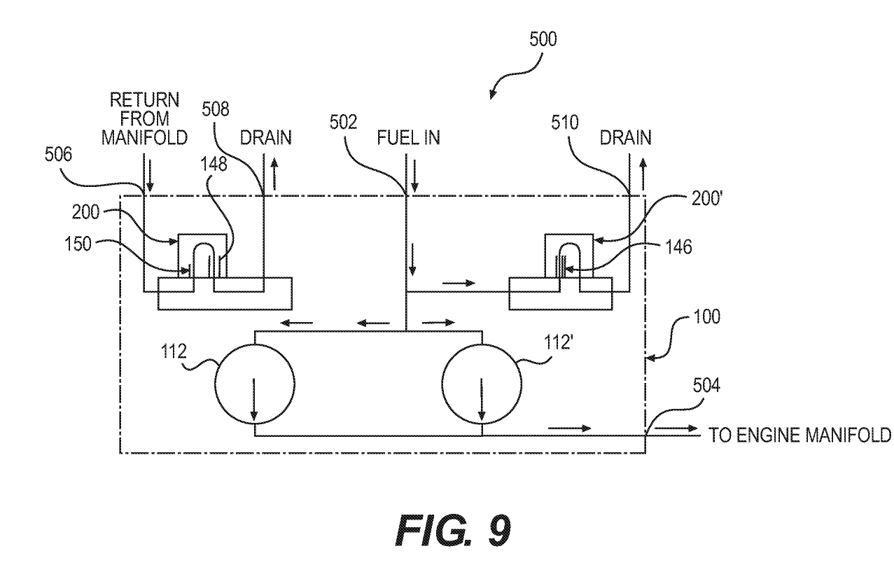

Once assembled, the fuel filter assembly may provide a fuel flow path 500 with other components of the engine as will now be described with reference to FIGS. 3 thru 5, while focusing on FIG. 9. In many embodiments, the apparatus and associated flow path is essentially the same as those already in the field, making retrofitting existing engines more easily done. In other embodiments, the apparatus and associated flow path may be varied as needed or desired.

Fuel flows from the fuel pump (not shown) into the fuel filter body 102 at the connection labeled ‘Fuel In’ (labeled 502 as well). This fuel flows to both of the filters 112 in parallel. Filtered fuel next flows from the filters 112 out of the fuel filter body 102 through the connection labeled ‘To Engine Manifold’ (labeled 504 as well). Fuel next flows into all of the engine's unit fuel injectors (not shown) in parallel. Excess fuel, not used for combustion, is used to cool the injectors and is returned to the fuel block connection labeled ‘Return From Manifold’ (labeled 506 as well). Fuel next flows against the 5 PSI injector fill check valve (relief valve 150) (provides resistance to make sure all injectors get filled) and into the inboard (mounting flange end) fuel accumulator silo 200. Fuel next flows out of the inboard fuel accumulator silo 200, via the standpipe 148, and to the fuel block connection ‘Drain’ (labeled 508) that is closest to the inboard (mounting flange end) fuel accumulator silo, and back to the fuel tank (not shown).

Normally, fuel does not flow into the outboard (free end) fuel accumulator silo 200′ unless the fuel pressure into the filters 112 approaches the nominal rating of the 60 PSI fuel system relief valve 146, located inside of the outboard (free end) fuel accumulator silo 200′. When fuel does begin to flow past the 60 PSI fuel system relief valve 146 (because the fuel filters are becoming dirty or clogged with debris), engine power is reduced because the fuel that flows past the 60 PSI fuel system relief valve fills up the outboard (free end) fuel accumulator silo 200′ and flows out from the fuel block connection ‘Drain’ (labeled 510) that is closest to the outboard (free end) fuel accumulator silo 200′, back to the fuel tank.

For any of the embodiments discussed herein, the threaded connection or interface could be on any surface such as the concave or convex circumferential surface of an annular recess of the fuel body. Similarly, the threaded connection or interface could be on the outer or inner circumferential surface of the skirt of an end cap or fuel silo, etc.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. An end cap for use with a fuel filter assembly including a fuel filter body, the end cap comprising:
a substantially annular cylindrical body defining a cylindrical axis and including an annular skirt portion defining a free open end along the cylindrical axis and a closed end opposite the free open end along the cylindrical axis;
the body defining an interior space; and
the annular skirt portion includes an outer circumferential surface including a threaded portion disposed proximate the free open end.

2. The end cap of claim 1 wherein the body includes a large faceted portion that is disposed proximate the closed end.

3. The end cap of claim 2 wherein the body includes a small faceted portion that is disposed on top of the large faceted portion.

4. The end cap of claim 3 wherein the small faceted portion includes a plurality of faces defining surface normals that are substantially perpendicular to the cylindrical axis of the body.

5. The end cap of claim 4 wherein a plurality of faces of the small faceted portion define a hole extending through the small faceted portion along a direction parallel with a surface normal.

6. The end cap of claim 4 further comprising a pressure sensor and wherein the small faceted portion is disposed about the pressure sensor.

7. The end cap of claim 2 wherein the large faceted portion has essentially four sides.

8. The end cap of claim 4 wherein the small faceted portion has essentially six sides.

9. The end cap of claim 1 wherein the closed end defines a top surface that defines at least one hole proximate the annular skirt.

10. The end cap of claim 9 wherein the annular skirt defines a cross-bore that extends in a direction non-parallel to the cylindrical axis from the outer circumferential surface to the at least one hole proximate the annular skirt.

11. A fuel filter body for use with a plurality of end caps and filters as part of a fuel filter assembly, the fuel filter body comprising:
a body defining a top surface and a bottom surface;
wherein the bottom surface includes a plurality of attachment portions configured to couple with a plurality of filters; and
the top surface defines a plurality of annular recesses, dividing the body into a first central core portion and a second central core portion, each annular recess defining a bottom face and a cylindrical surface with threads extending from the top surface toward the bottom face of the annular recess.

12. The fuel filter body of claim 11 wherein the second central core defines a top face defining a first threaded bore and a second unthreaded bore.

13. The fuel filter body of claim 11 wherein the first central core defines a top face defining a third threaded bore and a fourth threaded bore, wherein the third threaded bore defines a first diameter and the fourth threaded bore defines a second diameter and the first diameter is less than the second diameter.

14. The fuel filter body of claim 11 wherein the plurality of annular recesses are similarly configured and the first and second central core portions are also similarly configured.

15. A filter assembly comprising:
a filter body including
a body defining a top surface and a bottom surface;
wherein the bottom surface includes a plurality of attachment portions configured to couple with a plurality of filters; and
the top surface defines first and second annular recesses, dividing the body into a first central core portion and a second central core portion, each annular recess defining a bottom face and a concave cylindrical surface facing a central core portion and including threads extending from the top surface toward the bottom face of the annular recess;
a plurality of filters coupled to the attachment portions of the filter body;
a first silo including
a first substantially annular cylindrical body defining a first cylindrical axis and including a first annular skirt portion defining a first free open end along the first cylindrical axis and a first closed end opposite the first free open end along the first cylindrical axis;
the first substantially annular cylindrical body defining a first interior space; and
the first annular skirt portion includes a first outer circumferential surface including a first threaded portion disposed proximate the first free open end, the first threaded portion of the first silo mating with the threads of the first annular recess, forming a first interface; and
a second silo including
a second substantially annular cylindrical body defining a second cylindrical axis and including a second annular skirt portion defining a second free open end along the second cylindrical axis and a second closed end opposite the second free open end along the second cylindrical axis;
the second substantially annular cylindrical body defining a second interior space; and
the second annular skirt portion includes a second outer circumferential surface including a second threaded portion disposed proximate the second free open end, the second threaded portion of the second silo mating with the threads of the second annular recess, forming a second interface.

16. The filter assembly of claim 15 wherein a sealant is applied at the first interface between the first silo and the fuel filter body and at the second interface between the second silo and the filter body.

17. The filter assembly of claim 15 wherein the first and second silos are identically configured.

18. The filter assembly of claim 15 wherein the first and second silos each include a closed end defining a top surface that defines at least one hole proximate the annular skirt and the first and second silos each include an annular skirt defining a cross-bore that extends in a direction non-parallel to the cylindrical axis from the outer circumferential surface to the at least one hole proximate the annular skirt.

19. The filter assembly of claim 15 wherein the second central core defines a first top face defining a first threaded bore and a second unthreaded bore, the first central core defines a second top face defining a third threaded bore and a fourth threaded bore, wherein the third threaded bore defines a first diameter and the fourth threaded bore defines a second diameter and the first diameter is less than the second diameter.

20. The filter assembly of claim 19 further comprising a first relief valve coupled to the first threaded bore, a standpipe coupled to the third threaded bore, and a second relief valve coupled to the fourth threaded bore.
